(19) United States
(12) Patent Application Publication
(10) Pub. No.: US 2016/0378884 A1
(43) Pub. Date: Dec. 29, 2016

(54) SYSTEM FOR CONTEXTUAL ADAPTATION OF PHYSICAL SPACE

(71) Applicant: Intel Corporation, Santa Clara, CA (US)

(72) Inventors: Anna Galli Kagamihata, Hillsboro, OR (US); Yoav Hochberg, Haifa (IL); Paul L. Kandel, Haifa (IL); Glen J. Anderson, Beaverton, OR (US); Ido Lapidot, Haifa (IL); Tamara Gaidar, Haifa (IL)

(21) Appl. No.: 14/752,819

(22) Filed: Jun. 26, 2015

(51) Int. Cl. G06F 17/50

(52) U.S. Cl. CPC G06F 17/5004

(57) ABSTRACT

Embodiments are generally directed to a system for contextual adaptation of physical space. An apparatus may include a processor to process data regarding a physical space; logic, implemented at least in part in hardware, to monitor the physical space, including monitoring of sensor data and scheduling data for the physical space; an algorithm to generate a revised configuration for the physical space based at least in part on the sensor data and the scheduling data; and an output display to display the revised configuration for the physical space.

### TECHNICAL FIELD

Embodiments described herein generally relate to the field of electronic systems and, more particularly, to a system for contextual adaptation of physical space.

### BACKGROUND

Physical spaces for purposes such as living, working, commerce, and entertainment are increasingly becoming connected by network connections, such as the developing Internet of Things. Such connections allow for operations such as security and monitoring and environmental control for such spaces.

However, while certain appliances within a physical space may be connected and remotely controllable, the layouts of spaces such as homes, businesses, and institutions are fixed for the most part and are not easily modified. While certain physical space include room dividers that may serve to divide a large space into multiple smaller spaces, this simply divides a space in a simple manner without adjusting any other aspect of the physical space. If needs arise for a different layout for a physical space, such a change will require planning and significant labor, even if the space does not include permanent walls or other immobile structures.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of an adaptable physical space, according to an embodiment;

FIG. 2 is a block diagram to illustrate elements of a system for contextual adaptation of physical space, according to an embodiment;

FIG. 3 is an illustration of a living space plan with adaptive elements to provide contextual adaptation of the physical space, according to an embodiment;

FIG. 4 is a flowchart to illustrate a process for contextual adaptation of physical space according to an embodiment; and

FIG. 5 is an illustration of an embodiment of an electronic apparatus or system providing for support of contextually adaptive space, according to an embodiment.

### DETAILED DESCRIPTION

Embodiments described herein are generally directed to a system for contextual adaptation of physical space.

For the purposes of this description:

“Physical space” means any space or sub-space within a physical structure.

“Adaptive element” means any element in a physical space that may be adapted or modified (including moving, changing shape, shifting operation, or other change) to adapt a usage of the physical space.

In conventional settings, physical spaces are not easily modified to meet required that have not been designed into the current layout. Some multipurpose rooms, such as large conference rooms in hotels, have partitions that may be used to divide the room. Some of these operate on an actuator that can open or close a partition using motorized drives. However, the opening or closing of a partition does not allow for the physical space to be modified in response to a particular need, and does not provide any assistance in addressing any other requirements in changing the physical layout, such as designing a modified physical space based on needs and desire changing the position or use of physical items such as furniture; changing light, audio, or other electronic elements;

For example, there may be varying needs in a home environment, such as requirements when residents are hosting a party or other gathering, or requirements when there is a need for more segmented private areas, and residents have limited choices in how to adjust the environment to meet such requirements.

In another example, in a space such as a hospital, there may be differing spatial needs at different times. During an epidemic circumstance, more segmentation of rooms is needed for quarantine, which may be contrary to normal medical operations. While moveable partitions may be available, the setup of such partitions is generally very manual, without any intelligence in the system to assist in designing a proper layout.

Further, some factory floors include mobile, modular stations. These stations can be reconfigured for various runs of a product. However, the type of system is predetermined for a run of a product. Such a system does not provide intelligence in the configuration of the factory environment. For example, there is no provision for monitoring to understand the best possible configurations.

In some embodiments, a system for contextually adaptation of physical space provides for intelligent adaptability of a physical space based on context, including monitoring use of a physical space by persons and machines, generating a revised configuration of the physical space according to a current or future context, and, if desired by a user, automating the implementation of the new layout. In some embodiments, a system may include monitoring of a physical space that is being utilized for a current task, identifying problems and possible solutions, and suggesting changes in the environment. Thus, the system can allow for continually improving a physical environment as both dramatic and gradual changes occurs.

In some embodiments, a system for contextually adaptation of physical space can provide semi-custom facilities and spaces for users as the needs of the users change. In some embodiments, a system for contextually adaptation of physical space in a home may operate to meet the needs of people who hold events in the home, have visitors or additions to their family, or otherwise have new requirements for their living spaces. In some embodiments, a computer model may be applied to understand resident goals and preferences, model real spaces, test the reaction of residents (including in 3D models with virtual reality), and adapt the design to the needs and desires of the residents. In some embodiments, the furniture, lighting, and space itself may all include sensors that feed heuristics to understand the current use and current needs, and adapt accordingly.

In some embodiments, a system includes sensing and tracking operations in a physical space to change the space dynamically based on specific needs. In a particular example of a home physical environment, a system may respond to need such as:

(a) Having guests over for a dinner party, requiring extended table areas for dining, which may be shifted to open entertaining areas prior to or after dining;

(b) Watching a ball game or film, which may require a room rearrangement to provide several sitting areas in a large are to face a viewing screen, including, for example, removal of one or more partitions;

(c) Supporting an overnight guest, such as one or more visiting family members, which may require conversion of one or more spaces to provide private or semi-private sleeping areas;

(d) Hosting a sleepover party for children, which may require movement of furniture to provide a space for the children, as well as, for example, low light to allow adults to check on the children overnight if necessary.

(e) Moving furniture out of the way when room is needed to move large items or accommodate a wheelchair.

Other arrangements may be applied in other settings, such as-rearranging furniture or room partitions in hospital rooms and wards, rearranging machinery based on current tasks or workloads, reconfiguring office space based on scheduled activities, and reconfiguration of education space based on course schedule, class size, and educational needs.

In operation, a system to provide contextual adaptation of physical space provides for generating suggestions for use of space that a resident may not have considered, thus providing new uses for a space. Further, the system may operate to institute a reconfiguration ahead of time for a schedule event so that the user does not have to wait for reconfiguration for a particular use. In some embodiments, the system may further adapt to one or more user preferences in the reconfiguration of physical space.

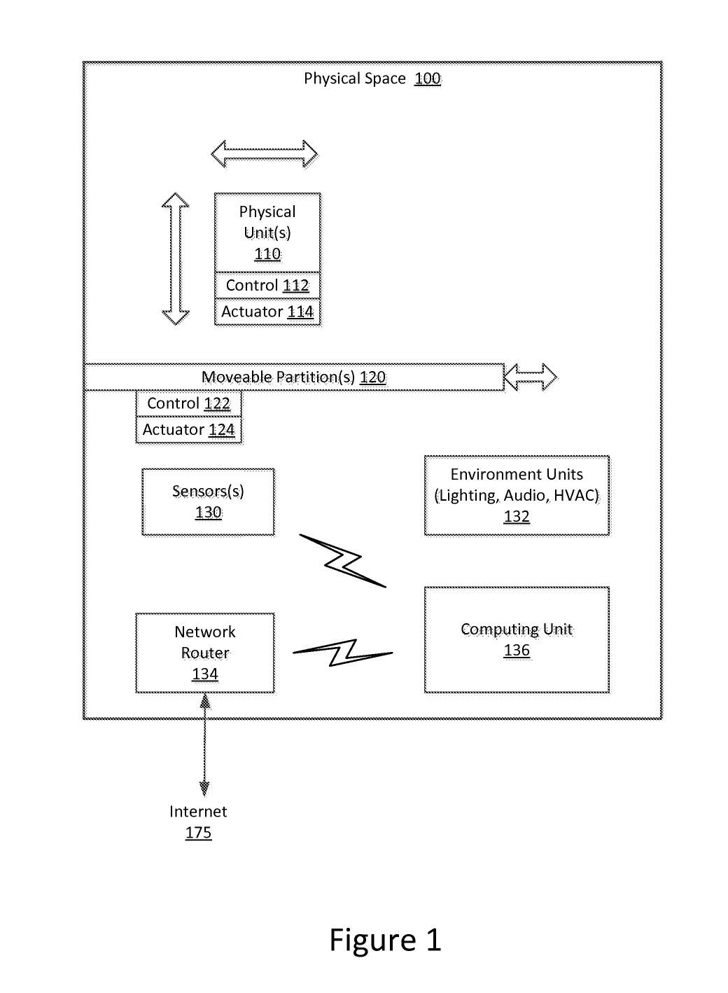

FIG. 1 is an illustration of an adaptable physical space, according to an embodiment. In some embodiments, the physical space 100 may be any physical space in which there are varying activities, including a home environment, a manufacturing operation, a business environment (such as a location with office and conference spaces), a medical institution (such as a hospital), or an educational institution (such as a college or university).

In some embodiments, a system for contextual adaptation of the physical space 100 may include:

(a) One or more adaptable physical units 110, including a control 112 to control movement and other adaptation in response to an instruction and an actuator 114 to provide for adaptation operation of the physical units. Physical units 110 may include, but are not limited to, furniture and machinery. While the illustration in FIG. 1 illustrates the physical units 110 moving in any direction, embodiments are not limited to these actions, and may include the physical units operating to rotate in any direction, to expand or collapse (such as a table that may lengthen or shorten), to be raised or lowered (such as a table that raises or lowers in height), and other adaptations.

(b) One or more moveable partitions (also referred to as dividers or room dividers) 120 to allow the physical space to be divided into multiple sub-spaces, including a control 122 to control movement and other adaptation in response to an instruction and an actuator 124 to provide for adaptation of the partitions 120. The partitions may include partitions running on tracks, but may also include track-less or free-standing partitions that are not limited to particular locations within the physical space 100. In some embodiments, the walls of the physical space 100 are built to support adaptability, either as a new construction or in a remodel of the physical space.

In some embodiments, data for the system may include a set of properties for certain elements that may affect the adaptation of such elements. In an example, there may be a particular set of properties for each of the partitions 120, and such properties that may affect how such partitions are applied in reconfiguration. Properties may include, but are not limited to, restriction of air flow, sound and temperature insulation, restriction of light through or around the partitions, and other properties. For example, in the use of partitions in a hospital setting, such as during an epidemic or other crisis situation, it may be necessary that the partitions be capable of sufficiently restricting air ventilation to maintain quarantine requirements, and certain partitions may or may not have sufficient properties to be utilized in a particular configuration.

(c) Sensors 130 to detect persons, animals, and inanimate objects within the physical space; detect environmental conditions; and otherwise detect the current activity within the physical space.

(d) Environmental units 132, including elements such as lighting, audio, video, HVAC (heating, ventilation, and air conditioning), all of which may be adjusted according to a contextual adaptation plan for the physical space 100.

(e) A network router 134, such as a wireless (WiFi or other wireless protocol) router for the physical space 100, which may be connected the Internet 175 or other network.

(f) A computing unit 136 to receive data from at least the sensors 130 and the network router 134, and to provide commands to the adaptive elements of the physical space (physical units 110, partitions 120, and environmental units 132) in accordance with a contextual adaptation plan for the physical space 100. In some embodiments, the computing unit 136 may generate a revised configuration for the physical space, which may include generating one or more of adaptation suggestions or contextual adaptation plans. In other embodiments, the revised configurations may be generated by an external unit, such as a central server for a larger space, and the computing unit 136 operates to implement instructions for a received contextual adaptation plan.

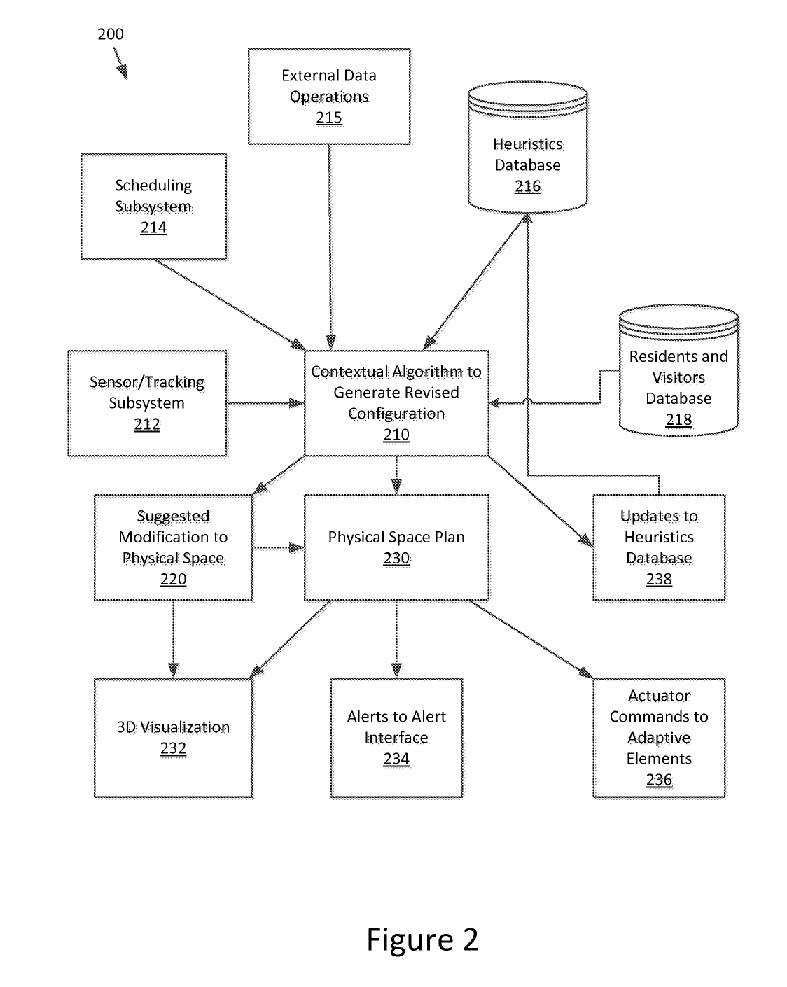

FIG. 2 is a block diagram to illustrate elements of a system for contextual adaptation of physical space, according to an embodiment. In some embodiments, a system for contextually adaptation of physical space 200 provides for contextual adaptation of a certain physical space, such as the physical space 100 illustrated in FIG. 1.

In some embodiments, a system 200 may include multiple elements operating together, wherein the elements may include:

(a) A sensing and tracking subsystem 212, which may, for example, monitor foot traffic, objects that could be in the way, times of use of portions of the physical space, identity of persons who are using the space, audio volume levels (especially television and stereo value), human voice, and human emotion and emotional reactions. Sensor arrays for the subsystem may include a variety of sensors, including: cameras (2D, 3D, infrared), microphone arrays, motion sensors, chemical sensors, etc. In some embodiments, location sensors may track locations of individuals within a physical space in order for the system to be aware of likelihoods as to where within the physical space, such as in which rooms within a house, the individuals will located within specific time slots. In some embodiments, wearable electronic devices may include sensors to allow interpretation of emotional state or interest level in a design, especially in response to environmental stimuli, and to interpret current activity.

(b) A scheduling subsystem 214, which may include shared schedules of activities for persons or entities utilizing a physical space. The scheduling subsystem 214 may include shared schedules of upcoming special events in the physical space, while regular activities may be monitored and identified by the sensor and tracking subsystem. In some embodiments, the overall physical space may include a schedule that is separate from and synchronizes with schedules of individuals to allow analysis of multiple competing schedules and allow priority to be given to certain individuals. For example, in a home environment, the home schedule may provide for priority of parents over children.

(c) External data operations 215 may include any external data source that is monitored and that may result in contextual adaptation of the physical space. In an example, a source of emergency response information may be utilized by a hospital to commence contextual adaptation in response to a large traffic accident or other event in which there are a large number of injuries.

(d) A database of heuristics 216 for configurations and uses of a space, including information regarding how to optimize the configuration for certain sensed conditions, and how to change space to accommodate certain sensed physical and emotional needs. The database may include certain rules for the physical space to trigger certain reconfigurations upon certain circumstances. In some embodiments, database may further include properties of physical units and partitions within a physical space, where such properties can affect or restrict how such elements may be applied.

(e) A database of residents and visitors 218 with relevant information for such individuals. In some embodiments, the information may include special needs of certain, such as the need for sufficient space to allow use of wheelchair for a certain individual, or the need for quarantine for a hospital patient. In some embodiments, the database further includes one or more user preferences in the reconfiguration of physical space. In an example, a user may have strong preferences regard temperature and light, such as preferring a cooler temperature and low light conditions.

(f) One or more contextual algorithms 210 to receive information, such as data from sources 212-218, which may include monitoring sensor to determine activities, emotion, presence and identification of people, and environmental occurrences, such as a door closing, within certain areas. In some embodiments, the contextual algorithm 210 may generate a revised configuration for the physical space, wherein the revised configuration may include:

(1) Suggested adaptations to the physical space 220, which may be presented in various forms, including 3D visualization to allow users to evaluate and modify suggested modifications to physical space.

(2) A contextual adaptation plan for the physical space 230, which may include a current adaptation arrangement and one or more future adaptation arrangements for different time periods based on the inputs 212-218.

(3) Updates 238 to the heuristics database 216 to allow for continual improvement of adaptation planning and implementation.

In some embodiments, a physical space plan 230, in addition to providing for a 3D visualization, may result in issuance of:

(1) Actuator commands to adaptive elements in a physical space, including physical units 110, moveable partitions of dividers 120, and environmental units 132 illustrated in FIG. 1.

(2) Alerts to an alert interface 234 for the system. Alerts may include warnings regarding upcoming adaptations, alerts to inform a resident that if certain objects will prevent a certain reconfiguration. The alert may be transmitted to a smartphone, television, computer terminal, smartwatch or other wearable electronic device.

In some embodiments, an apparatus to provide contextual adaptation of a physical space includes a processor to process data regarding a physical space; logic, implemented at least in part in hardware, to monitor the physical space, including monitoring of sensor data and scheduling data for the physical space; an algorithm to generate a revised configuration for the physical space based at least in part on the sensor data and the scheduling data; and an output display to display the revised configuration for the physical. In some embodiments, the logic may include, but is not limited to, an FPGA (Field Programmable Gate Array) or ASIC (Application Specific Integrated Circuit) to provide monitoring of a physical space.

In some embodiments, an apparatus to provide contextual adaptation of a physical space further includes one or more of a database of user information regarding residents, visitors, or both of the physical space, wherein the generation of the revised configuration a the physical space is further based at least in part on the user information, and a database of heuristic data for the physical space, wherein the generation of the revised configuration for the physical space is further based at least in part on the heuristic data for the physical space. In some embodiments, the apparatus further includes logic, implemented at least in part in hardware, to automatically implement the revised configuration. In some embodiments, the apparatus further includes a transmitter for transmission of signals, wherein the logic to automatically implement the revised configuration is to transmit adaptation commands to one or more adaptive elements of the physical space to implement the revised configuration.

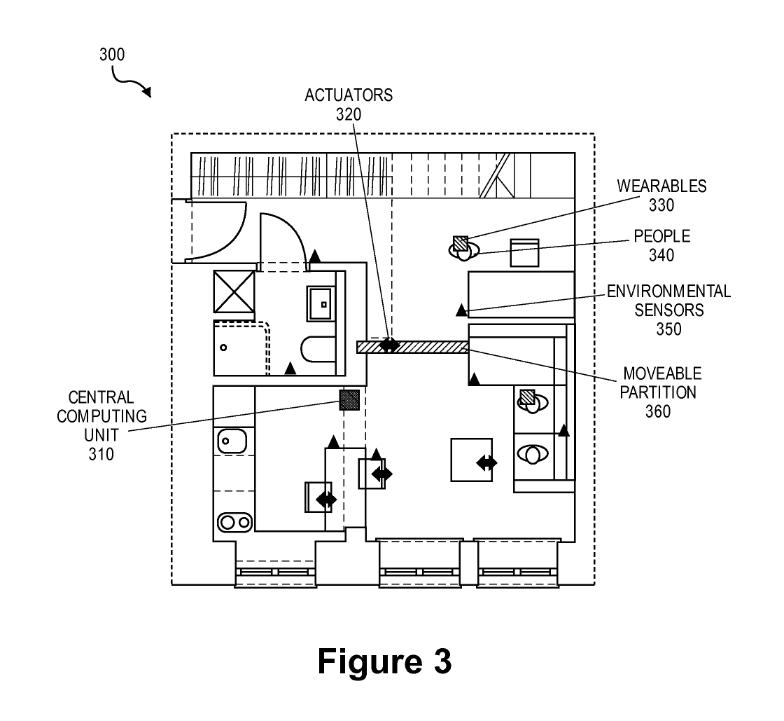

FIG. 3 is an illustration of a living space plan with adaptive elements to provide contextual adaptation of the physical space, according to an embodiment. In some embodiments, a physical space may include a home or portion of a home. In this example, the home 300 includes a central computing unit 310 for processing of contextual adaptation factors; actuators 320 to provide for automatic adaptation of the physical space upon command; environmental sensors 350 to detect current uses of the physical space and other factors; and moveable partitions 360 to change the arrangement of the space within the home. In addition, the system may sense wearables 330 worn by people 340 within the environment, which can assist in determining the location of residents in the environment.

In some embodiments, rules for the particular physical space of the home 300, such as stored in a database of heuristics (such as illustrated as 216 in FIG. 2) may include the examples provided in Table 1.

TABLE 1

| Conditions | Rules | Action |
|---|---|---|
| Noise level in TV | Close partition | Partition A to close |
| area >60 db (Decibels) | between adjacent | immediately |
| Father cooking in kitchen | areas if db differ- | |
| No conversation between | ence >45, if no | |
| TV area and kitchen in | ongoing conversation | |
| previous 20 seconds | between the adjacent | |
| Partition A currently | areas | |
| open | | |
| Grandmother coming to | Expand main pathways | Move couch 8 inches |
| visit at dinner, where her | to accommodate | south at 2PM (to make |
| profile in database | wheelchairs | path from TV area to |
| includes use of a | | kitchen comfortable |
| wheelchair | | width of 40 inches) |
| Partition A currently | | Open partition A |
| closed | | at 2 PM |
| Dinner party scheduled | Expanded dining | Move living room |
| 6-9 pm | area at dinner time | couch 5 feet west |
| Greeting and drinks in | | Move dining table and |
| living area 6-7:30 | | chairs 5 feet west |
| Dinner at 7:30 | | |
| Current time 6:25 | | |
| Living room expanded - | | |
| dining area reduced | | |

Other examples may include:

Hospital—A hospital may include an adaptable waiting and treatment space for emergency room operations that adapts as conditions change. In a low use time period, the arrangement may allow for significant waiting space for the comfort of visitors. However, in high use time periods, the arrangement may shift the space to emergency personnel usage to ensure there is sufficient space for triage and treatment of patients.

College or University—A college may include an adaptable educational space that may be adapted as one or more large teaching spaces, or several smaller classrooms, depending on the particular class schedule and other factors. For example, schedule information may include university class schedule information, which may be utilized to rearrange space into classroom space that most efficiently allocates the total space available. In this example, schedule information may further include professor teaching plans, which may include information that will result in a particular room arrangement and particular teaching requirements (such as audio-visual needs, demonstration space, and other elements).

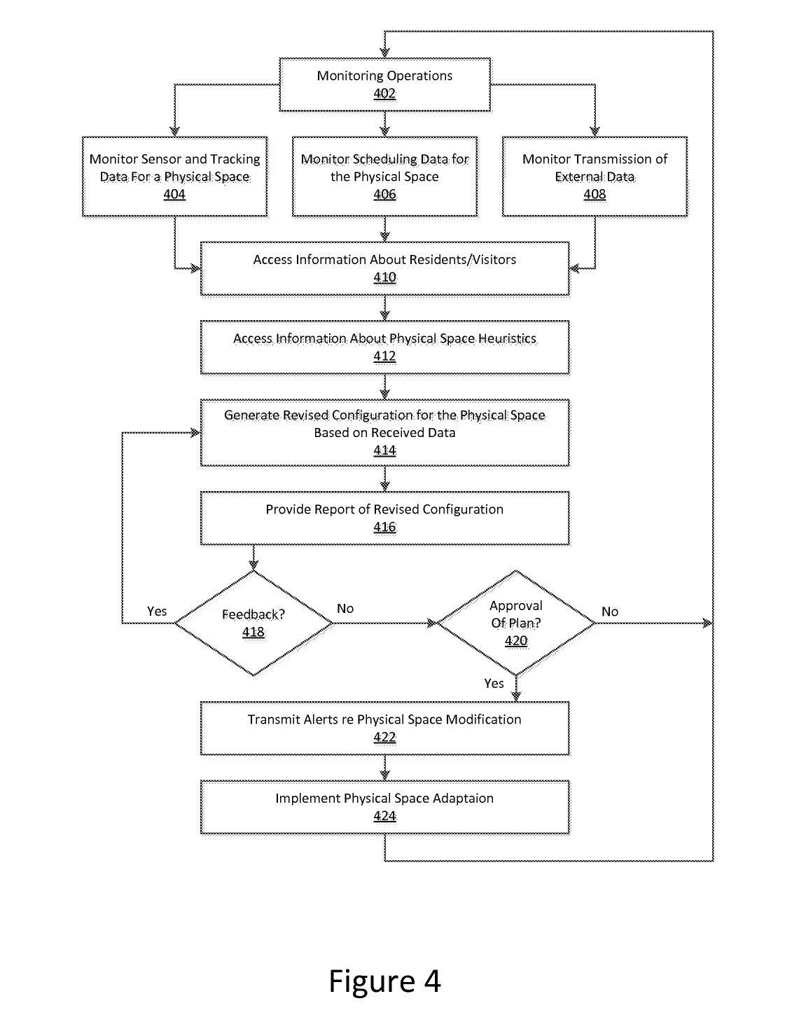

FIG. 4 is a flowchart to illustrate a process for contextual adaptation of physical space according to an embodiment. In some embodiments, in operation a system for contextual adaptation of a physical space may provide for continual monitoring operations 402 to determine what changes in usage are currently occurring and what future changes are scheduled or expected. In some embodiments, the monitoring operations may include one or more of monitoring sensor and tracking data for a physical space 404; and monitoring scheduling data for the physical space 406, including scheduling data for users of the physical space. In some embodiments, monitoring may further include monitoring transmissions of external data 408.

In some embodiments, the process may further include accessing information about users (residents and visitors of the physical space) 410, such as accessing a residents and visitors database 218 illustrated in FIG. 2, and accessing information about physical space heuristics, such as accessing a heuristics database 216 illustrated in FIG. 2.

In some embodiments, the process continues with generating a revised configuration for the physical space 414 based on received data, wherein the revised configuration may include physical space recommendations or a physical space plan, depending on the implantation. In some embodiments, a report of the revised configuration may be made to users of the space 416.

In some embodiments, if the users have feedback regarding the revised configuration 418, the process may return to generating another iteration of the revised configuration 414. If not, upon approval of a plan for reconfiguration of the physical space 420, there may be alerts regarding adaptation of the physical space 422, and implementation of the physical space adaptation 424, including sending commands to one or more adaptive elements in the physical space.

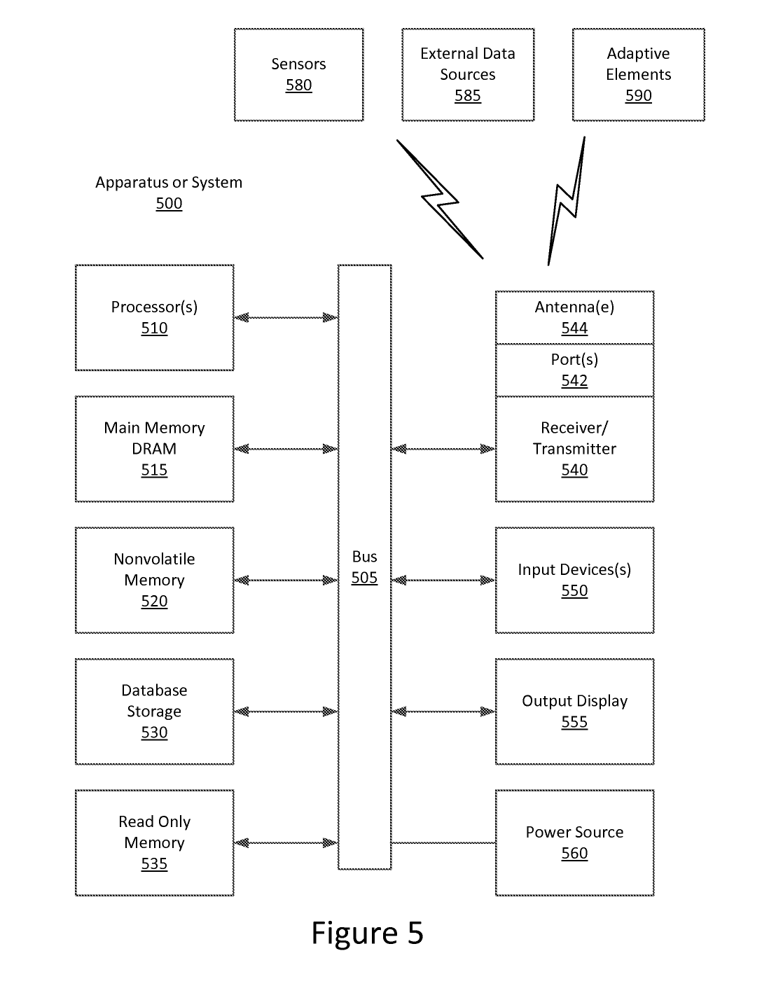

FIG. 5 is an illustration of an embodiment of an electronic apparatus or system providing for support of contextually adaptive space, according to an embodiment. In this illustration, certain standard and well-known components that are not germane to the present description are not shown. Elements shown as separate elements may be combined, including, for example, an SoC (System on Chip) combining multiple elements on a single chip. The apparatus or system (referred to generally as a system 500) may include, but is not limited to, a computing system.

In some embodiments, the system 500 may include a processing means such as one or more processors 510 coupled to one or more buses or interconnects for processing information, shown in general as bus 505. The processors 510 may comprise one or more physical processors and one or more logical processors. In some embodiments, the processors may include one or more general-purpose processors or special-processor processors.

The bus 505 is a communication means for transmission of data. The bus 505 is illustrated as a single bus for simplicity, but may represent multiple different interconnects or buses and the component connections to such interconnects or buses may vary. The bus 505 shown in FIG. 5 is an abstraction that represents any one or more separate physical buses, point-to-point connections, or both connected by appropriate bridges, adapters, or controllers.

In some embodiments, the system 500 further comprises a random access memory (RAM) or other dynamic storage device or element as a main memory 515 for storing information and instructions to be executed by the processors 510. Main memory 515 may include, but is not limited to, dynamic random access memory (DRAM).

The system 500 also may include nonvolatile memory 520 and a database storage 530. The system 500 may further include a read only memory (ROM) 535 or other static storage device for storing static information and instructions for the processors 510. Stored data may include, but is not limited to, data for the scheduling subsystem 214, data for the heuristics database 216, and data for the residents and visitors database 218 illustrated in FIG. 2.

In some embodiments, the system 500 includes one or more transmitters or receivers 540 coupled to the bus 505. In some embodiments, the system 500 may include one or more antennae 544, such as dipole or monopole antennae, for the transmission and reception of data via wireless communication using a wireless transmitter, receiver, or both, and one or more ports 542 for the transmission and reception of data via wired communications. Wireless communication includes, but is not limited to, Wi-Fi, Bluetooth™, near field communication, and other wireless communication standards. In some embodiments, communications may include, but are not limited to, receiving sensor data from one or more sensors 580, receiving data from one or more external data sources 585, and sending actuator commands to one or more adaptive elements in a physical space 590, where adaptive elements include one or more physical units 110, moveable partitions of dividers 120, and environmental units 132 illustrated in FIG. 1.

In some embodiments, system 500 includes one or more input devices 550 for the input of commands and data, including hard and soft buttons, a joy stick, a mouse or other pointing device, a keyboard, voice command system, or gesture recognition system.

In some embodiments, the system 500 includes an output display 555, where the display 555 may include a liquid crystal display (LCD) or any other display technology, for displaying information or content to a user. In some environments, the display 555 may include a touch-screen that is also utilized as at least a part of an input device 550. Output display 555 may further include audio output, including one or more speakers, audio output jacks, or other audio, and other output to the user.

The system 500 may also comprise a battery or other power source 560, which may include a solar cell, a fuel cell, a charged capacitor, near field inductive coupling, or other system or device for providing or generating power in the system 500. The power provided by the power source 560 may be distributed as required to elements of the system 500.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, an apparatus includes a processor to process data regarding a physical space; logic, implemented at least in part in hardware, to monitor the physical space, including monitoring of sensor data and scheduling data for the physical space; an algorithm to generate a revised configuration for the physical space based at least in part on the sensor data and the scheduling data; and an output display to display the revised configuration for the physical.

In some embodiments, the apparatus further includes a database of user information regarding residents, visitors, or both of the physical space, wherein the generation of the revised configuration for the physical space is further based at least in part on the user information.

In some embodiments, the database of user information includes information regarding preferences of one or more residents or visitors.

In some embodiments, the apparatus further includes a database of heuristic data for the physical space, wherein the generation of the revised configuration for the physical space is further based at least in part on the heuristic data for the physical space.

In some embodiments, the apparatus further includes comprising logic, implemented at least in part in hardware, to automatically implement the revised configuration. In some embodiments, the apparatus further includes a transmitter for transmission of signals, wherein the logic to automatically implement the revised configuration is to transmit using the transmitter adaptation commands to one or more adaptive elements of the physical space to implement the revised configuration.

In some embodiments, a system includes a processing element to implement a contextual algorithm; a scheduling subsystem including schedule data for a physical space; a sensor subsystem including one or more sensors to produce sensor data for the physical space; and one or more adaptive elements to adapt the physical space, wherein the contextual algorithm is to generate a revised configuration for the physical space based on at least the sensor data and the schedule data.

In some embodiments, the system further includes a database including information regarding users of the physical space, the revised configuration being further based on the information regarding users of the physical space.

In some embodiments, the system further includes a database including heuristic data for the physical space, the revised configuration being further based on the heuristic data for the physical space.

In some embodiments, the database including heuristic data for the physical space includes properties of the adaptive elements.

In some embodiments, the processing element is to issue commands to the adaptive elements to implement the revised configuration.

In some embodiments, the adaptive elements include one or more physical units, each physical unit including a control to control adaptation of the physical unit and an actuator to provide for adaptation operation.

In some embodiments, the adaptive elements include one or more moveable partitions, each physical unit including a control to control adaptation of the partition and an actuator to provide for adaptation operation.

In some embodiments, the adaptive elements include one or more environmental elements for the physical space.

In some embodiments, a method includes monitoring of a physical space, including monitoring of sensors and scheduling for the physical space; obtaining sensor data and scheduling data for the physical space; generating a revised configuration for the physical space based at least in part on the sensor data and the scheduling data; and providing notice regarding the revised configuration.

In some embodiments, the method further includes accessing user information regarding residents, visitors, or both of the physical space, wherein generating the revised configuration for the physical space is further based at least in part on the user information.

In some embodiments, the user information includes information regarding preferences of one or more residents or visitors.

In some embodiments, the method further includes accessing heuristic data for the physical space, wherein generating the revised configuration for the physical space is further based at least in part on heuristic data for the physical space.

In some embodiments, the method further includes automatically implementing the revised configuration.

In some embodiments, automatically implementing the revised configuration includes transmitting adaptation commands to one or more adaptive elements of the physical space.

In some embodiments, a non-transitory computer-readable storage medium having stored thereon data representing sequences of instructions that, when executed by a processor, cause the processor to perform operations including monitoring of a physical space, including monitoring of sensors and scheduling for the physical space; obtaining sensor data and scheduling data for the physical space; generating a revised configuration for the physical space based at least in part on the sensor data and the scheduling data; and providing notice regarding the revised configuration.

In some embodiments, the medium further includes instructions for accessing user information regarding residents, visitors, or both of the physical space, wherein generating the revised configuration for the physical space is further based at least in part on the user information.

In some embodiments, the user information includes information regarding preferences of one or more residents or visitors.

In some embodiments, the medium further includes instructions for accessing heuristic data for the physical space, wherein generating the revised configuration for the physical space is further based at least in part on heuristic data for the physical space.

In some embodiments, the medium further includes instructions for automatically implementing the revised configuration.

In some embodiments, automatically implementing the revised configuration includes transmitting adaptation commands to one or more adaptive elements of the physical space.

In some embodiments, an apparatus includes means for monitoring of a physical space, including monitoring of sensors and scheduling for the physical space; means for obtaining sensor data and scheduling data for the physical space; means for generating a revised configuration for the physical space based at least in part on the sensor data and the scheduling data; and means for providing notice regarding the revised configuration.

In some embodiments, the apparatus further includes means for accessing user information regarding residents, visitors, or both of the physical space, wherein generating the revised configuration for the physical space is further based at least in part on the user information.

In some embodiments, the user information includes information regarding preferences of one or more residents or visitors.

In some embodiments, the apparatus further includes means for accessing heuristic data for the physical space, wherein generating the revised configuration for the physical space is further based at least in part on heuristic data for the physical space.

In some embodiments, the apparatus further includes means for automatically implementing the revised configuration.

In some embodiments, the means for automatically implementing the revised configuration includes means for transmitting adaptation commands to one or more adaptive elements of the physical space.

1. An apparatus comprising:
a processor to process data regarding a physical space;
logic, implemented at least in part in hardware, to monitor the physical space, including monitoring of sensor data and scheduling data for the physical space;
an algorithm to generate a revised configuration for the physical space based at least in part on the sensor data and the scheduling data; and
an output display to display the revised configuration for the physical space.

2. The apparatus of claim 1, further comprising a database of user information regarding residents, visitors, or both of the physical space, wherein the generation of the revised configuration for the physical space is further based at least in part on the user information.

3. The apparatus of claim 2, wherein the database of user information includes information regarding preferences of one or more residents or visitors.

4. The apparatus of claim 1, further comprising a database of heuristic data for the physical space, wherein the generation of the revised configuration for the physical space is further based at least in part on the heuristic data for the physical space.

5. The apparatus of claim 1, further comprising logic, implemented at least in part in hardware, to automatically implement the revised configuration.

6. The apparatus of claim 5, further a transmitter for transmission of signals, wherein the logic to automatically implement the revised configuration is to transmit using the transmitter adaptation commands to one or more adaptive elements of the physical space to implement the revised configuration.

7. A system comprising:
a processing element to implement a contextual algorithm;
a scheduling subsystem including schedule data for a physical space;
a sensor subsystem including one or more sensors to produce sensor data for the physical space; and
one or more adaptive elements to adapt the physical space;
wherein the contextual algorithm is to generate a revised configuration for the physical space based on at least the sensor data and the schedule data.

8. The system of claim 7, further comprising a database including information regarding users of the physical space, the revised configuration being further based on the information regarding users of the physical space.

9. The system of claim 7, further comprising a database including heuristic data for the physical space, the revised configuration being further based on the heuristic data for the physical space.

10. The system of claim 9, wherein the database including heuristic data for the physical space includes properties of the adaptive elements.

11. The system of claim 7, wherein the processing element is to issue commands to the adaptive elements to implement the revised configuration.

12. The system of claim 7, wherein the adaptive elements include one or more physical units, each physical unit including a control to control adaptation of the physical unit and an actuator to provide for adaptation operation.

13. The system of claim 7, wherein the adaptive elements include one or more moveable partitions, each physical unit including a control to control adaptation of the partition and an actuator to provide for adaptation operation.

14. The system of claim 7, wherein the adaptive elements include one or more environmental elements for the physical space.

15. A non-transitory computer-readable storage medium having stored thereon data representing sequences of instructions that, when executed by a processor, cause the processor to perform operations comprising:
monitoring of a physical space, including monitoring of sensors and scheduling for the physical space;
obtaining sensor data and scheduling data for the physical space;
generating a revised configuration for the physical space based at least in part on the sensor data and the scheduling data; and
providing notice regarding the revised configuration.

16. The medium of claim 15, further comprising instructions that, when executed by the processor, cause the processor to perform operations comprising:
accessing user information regarding residents, visitors, or both of the physical space, wherein generating the revised configuration for the physical space is further based at least in part on the user information.

17. The medium of claim 16, wherein the user information includes information regarding preferences of one or more residents or visitors.

18. The medium of claim 15, further comprising instructions that, when executed by the processor, cause the processor to perform operations comprising:
accessing heuristic data for the physical space, wherein generating the revised configuration for the physical space is further based at least in part on heuristic data for the physical space.

19. The medium of claim 15, further comprising instructions that, when executed by the processor, cause the processor to perform operations comprising:
automatically implementing the revised configuration.

20. The medium of claim 19, wherein automatically implementing the revised configuration includes transmitting adaptation commands to one or more adaptive elements of the physical space.
